(19) United States
(12) Patent Application Publication
(10) Pub. No.: US 2020/0413134 A1
(43) Pub. Date: Dec. 31, 2020

(54) SYSTEM AND METHOD FOR EFFECTIVE ADVERTISING ON A CLIENT DEVICE

(71) Applicant: NANNING FUGUI PRECISION INDUSTRIAL CO., LTD., Nanning (CN)

(72) Inventor: ZONG-XIAN LU, New Taipei (TW)

(21) Appl. No.: 16/454,162

(22) Filed: Jun. 27, 2019

(51) Int. Cl. H04N 21/442; H04N 21/258; H04N 21/441; H04N 21/262

(52) U.S. Cl. CPC H04N 21/44218; H04N 21/26233; H04N 21/441; H04N 21/25891

(57) ABSTRACT

A method, system for advertising, and client device allow a connected server to arrange display of advertisements suitable for users of a specific client device in view of their viewing history recorded and provided to advertisement providers. The client device obtains user identification information and user viewing information beyond mere control operations and transmits same to the server. The server updates a user preference information table according to the received data and updates of data, and requests at least one advertisement set according to the user preference information table. The server further performs data matching with a plurality of advertisement data in the received advertisement set to select at least one suitable advertisement and transmit the advertisement to the client device for display.

### FIELD

The subject matter herein generally relates to advertising.

### BACKGROUND

While a user is on a client device viewing a media stream, the client device collects only the input information from the user, and does not further deliver the advertisements according to the user's viewing behavior, neither is a display area reserved for advertising.

Existing third-party software installed on the client device, such as the iQiyi application or the NETFLIX application, only delivers new application version information, latest video information, or renewal plan of the account. Since advertisements are not accurately targeted according to different user behaviors overall, the advertising is not effective, and the value of the advertising is low.

Thus, there is room for improvement within the art.

### BRIEF DESCRIPTION OF THE DRAWINGS

Implementations of the present technology will now be described, by way of example only, with reference to the attached figures.

FIG. 1 is a block diagram of one embodiment of a working environment of an advertising system.

FIG. 2 is a flow chart of one embodiment of a method for advertising applied in the advertising system of FIG. 1.

FIG. 3 is a schematic diagram of one embodiment of a user preference information table.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

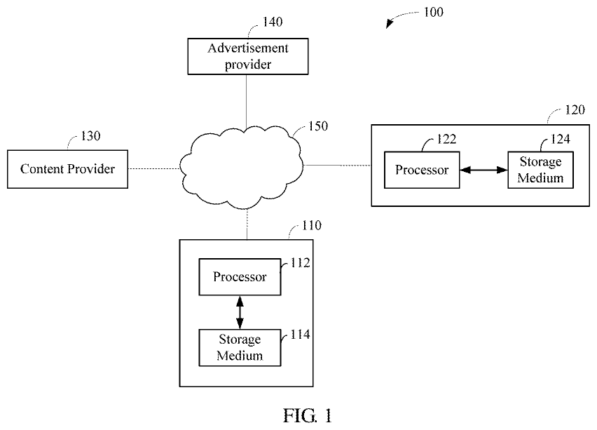

FIG. 1 illustrates an advertising system 100 according to an embodiment. The advertising system 100 includes a client device 110, and a server 120, a content provider 130, and an advertisement provider 140. The client device 110, the server 120, the content provider 130 and the advertisement provider 140 are connected through a network 150. In one embodiment, the client device 110 can be a personal computer, a notebook computer, a smart phone, a digital set-top box, a multimedia TV box, a smart connected TV, a multimedia playing device, or any other computer suitable for streaming and displaying multimedia. The client device 110 comprises a processor 112 and a storage medium 114. The storage medium 114 can be used to store at least one computer program and data generated during execution of the client device 110. The processor 112 runs computer programs stored in the storage medium 114 to implement various functions and data processing of the client device 110. The server 120 is a backend server of the client device 110. The server 120 comprises a processor 122 and a storage medium 124. The storage medium 124 can be used to store computer programs and data generated during execution. The processor 122 performs various functions and data processing of the server 120 by running computer programs stored in the storage medium 124.

The client device 110 can retrieve multimedia content from the content provider 130 through the network 150. The network 150 can be a combination of one or more wired or wireless networks, including the Internet, a mobile telephone network, a wide area network, a local area network, and the like. The client device 110 in the embodiment is a multimedia TV box, and the content provider 130 is a streaming platform provider that provides streaming multimedia to the client device 110 through the network 150, for example, iQiyi, Netflix, Hulu, etc. The advertisement (AD) provider 140 is configured to provide various advertisement sets, and each of the advertisement set comprises a plurality of advertisement data, wherein the advertisement data may be of a type such as an image, a text, a multimedia presentation, or the like. The server 120 is configured to perform data analysis according to the user behavior of the client device 110, and perform data matching with the advertisement sets provided by the advertisement provider 140 according to the result of analysis, to accurately deliver certain advertisement data to the client device 110.

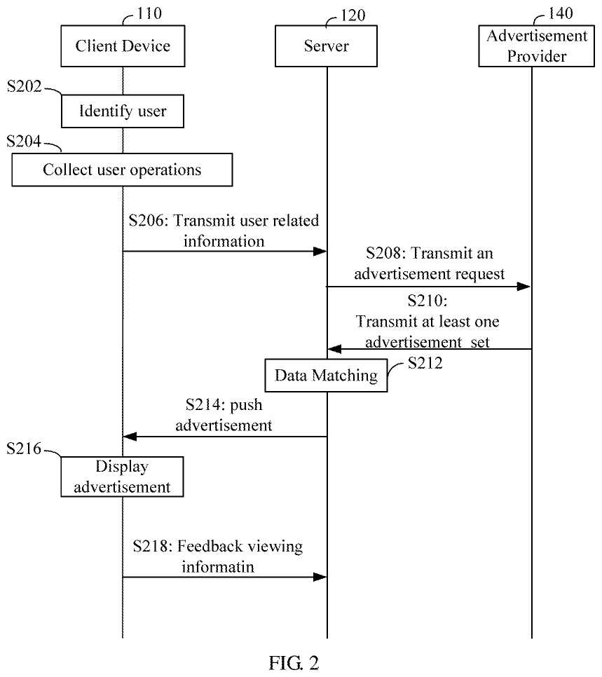

FIG. 2 illustrates a flowchart of a method for advertising of the advertising system 100 according to an embodiment.

When the client device 110 is powered on, a packet carrying the MAC address information and the IP address information of the client device 110 is transmitted to the server 120, so that the server 120 can obtain information as to area where the client device 110 is located. The MAC address information of the client device 110 can be used to uniquely identify the client device 110. The IP address information of the client device 110 can be used to determine the area where the client device 110 is located.

Step S202, the client device 110 performs user identification. The user identification information comprises, but is not limited to, gender, age range, and being adult viewer or child viewer. In one embodiment, the client device 110 may obtain user identification information through a fingerprint recognition function of a remote controller that of the client device 110. In another embodiment, after the client device 110 is powered on, the user needs to input an account and a password for logging in to the server 120, and establishing a communication with the server 120 to obtain streaming service provided by the content provider 130. In another embodiment, the client device 110 can also analyze operation behavior of the user and further determine the user's preferences for the purpose of identifying different users. For example, the operation behavior of the user can comprise user input through a remote controller of the client device 110.

Step S204, after the client device 110 identifies the user, the operation information and the viewing information of the user as user behavior information.

Specifically, the user behavior information comprises, but is not limited to, a user's selection within a video category menu, wherein the video categories comprise variety shows, animes, serial dramas, and others, and the manner in which the user browses the video list. For example, the user may select a video on a video recommendation region, a video that the user may add to “My Favorites”, and the user's viewing time for each selected video.

Step S206, the client device 110 transmits the user identification information and the user behavior information of the user to the server 120 after identifying the user and collecting the user behavior information. In one embodiment, an interval is configured into the client device 110 to periodically transmit updates of the user identification information and the user behavior information to the server 120. In another embodiment, in order to reduce the transmission frequency of the client device 110 and reduce the processing load of the server 120, the client device 110 may report and give update to the server 120 every time that the user makes a selection on the menu. The client device 110 can also report to the server 120 each time the user watches the video for more than a predetermined length of time. For example, the client device 110 can transmit the user identification information and the user behavior information to the server 120 when the user selects a specific video category or the user may be watching a certain video for more than ten minutes. The server 120 stores the user identification information and the user behavior information in the storage medium 124. In order to effectively utilize the storage space of the storage medium 124, in one embodiment, the server 120 stores only the last 50 entries of the latest user identification information and user behavior information.

In one embodiment, after receiving the user identification information and the user behavior information for the first time, the server 120 further generates a user preference information table 300, and updates the user preference information table 300 after receiving updates from the client device 110.

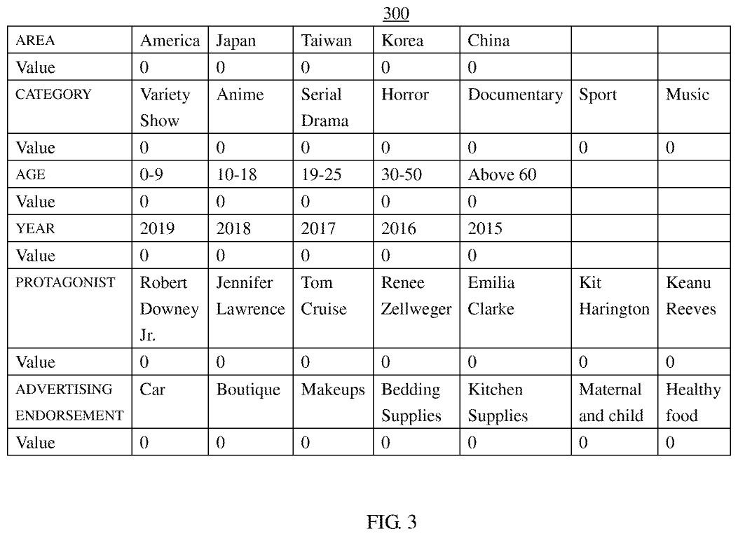

FIG. 3 shows an example of the user preference information table 300 in one embodiment. The user preference information table 300 can comprise a plurality of classified indicator lists and corresponding indicator values. For example, the user preference information table 300 comprises indicator lists of different classifications such as “area”, “category”, “age”, “year”, “protagonist”, and “advertising endorsement”. After receiving the user identification information and the user behavior information, the server 120 generates or updates the content of the user preference information table 300. For example, when the server 120 receives the user identification information as “age 32” and the name of the watched video as “A Song of Ice and Fire”, it searches for the indicator of “30-50” in the indicator list of the “age” classification. If there is a “30-50”, the server 120 increases the indicator value corresponding to the indicator. If there is no such “30-50” indicator, a “30-50” indicator is added to the indicator list of the “age” classification, and the corresponding indicator value is initiated as “0”. The server 120 also searches for related information of the video from the Internet according to the received video name or obtains related information of the video from the content provider 130 via the network 150. For example, the “A Song of Ice and Fire” is from the USA area, type is serial drama, and the broadcast year is 2019. The protagonists are Emilia Clarke and Kit Harington, and the protagonists have endorsed the advertisement of boutique, makeups, and car. The server 120 then updates the user preference information table according to the video information for which it searched, and the manner of updating is as described above.

Step S208, the server 120 transmits a request to display advertisements on a client device 110 (AD request) to the advertisement provider 140 periodically at a predetermined time interval, for example, one week, two weeks, one month, and the like, wherein the AD request comprising at least one indicator. In one embodiment, the server 120 may sort the plurality of indicator values in the user preference information table 300 from large to small, and select a predetermined number of indicators to be encapsulated into the AD request according to the sorted indicator values. For example, the server 120 looks up the user preference information table 300, and obtains the indicators corresponding to the first three larger indicator values as the serial dramas, Emilia Clarke, and the makeups, and then encapsulates the three indicators into an AD request and transmits the AD request to the advertisement provider 140. In one embodiment, the AD request may further comprise area information of the client device 110.

Step S210, after receiving the AD request, the advertisement provider 140 searches an advertisement pool according to the received indicator, selects at least one advertisement set, and sends the advertisement set to the server 120, wherein the advertisement set comprises a plurality of advertisement data. In another embodiment, the advertisement provider 140 may further select the advertisement set according to the area information of the client device 110 when searching for the advertisement pool. For example, the publishing area of the plurality of advertisement data in the advertisement pool may be associated with the area information of the client device 110, to select the appropriate advertisement set. For example, when a user is located in Japan, the user's operation behavior and the user's viewing behavior may reveal that the user likes to watch European and American serial dramas, in order to avoid the server 120 receiving advertisements which are appropriate for a user in the USA, the area information of the client device 110 is provided in the AD request to obtain an appropriate advertisement set for the area where the user is located.

Step S212, the server 120 performs data matching after receiving the advertisement set. In one embodiment, the server 120 may select a plurality of advertisement data from the advertisement set according to the stored user identification information and user behavior information. In another embodiment, the server 120 may further differentiate the classifications of indicator lists in the user preference information table 300 into majority indicators and non-majority indicators according to indicator properties. Herein, the majority indicators are related to the common preference of the majority of users of the client device 110, and the non-majority indicators are related to the characteristics of the users of the client device 110. For example, the majority indicators of the user preference information table 300 are the indicators of the protagonist and his or their advertising endorsements, and the non-majority indicator are the indicator of the area, category, age, and year. The server 120 may match the plurality of advertisement data from the advertisement set according to the majority indicators.

Step S214, the server 120 transmits the plurality of advertisement data to the client device 110.

Step S216, after receiving the plurality of advertisement data, the client device 110 waits for a suitable point or time to display advertising (AD display time). In one embodiment, the AD display time is when the video is paused in playback and when the client device 110 enters a sleep mode. The client device 110 can confirm that the user pauses playback while watching the video according the user operation information. Since the video playback is only paused, the user may resume, so one or more of the plurality of advertisement data received may be rendered on a display device of the client device through non-full-screen centered advertising. When the client device 110 enters the sleep mode, one or more advertisement data are selected from the plurality of received advertisement data to perform full-screen advertising.

Step S218, the client device 110 may further collect the browsing rate and the click rate of each advertisement data as the viewing information of the advertisement data, and periodically give update report to the server 120. In one embodiment, the server 120 may evaluate the advertisement data as an on-target advertisement or an off-target advertisement according to the browsing rate and the click rate of each advertisement data, thereby optimizing the data matching of step S212. For example, if the advertisement data is an off-target advertisement, the advertisement data will not be selected the next time. The server 120 can also report the off-target advertisement data to the advertisement provider 140, so that the advertisement provider 140 can further modify advertisement tags to manage the advertisement pool.

It should be noted that although the embodiment of FIG. 2 relates to different devices such as the client device 110, the server 120, and the advertisement provide 140, in another embodiment, the steps performed by the server 120 can be performed by the client device 110 alone.

By such method for advertising, the client device, and the system provided in this embodiment can quickly and accurately deliver the advertisement content to the user by collecting the user's identification information and behavior information. At the same time, by feedback, the advertisement provider can update his advertisement labels, and further align his advertisement content to be closer to the user's preferences and needs.

The embodiments shown and described above are only examples. Many details are often found in the art such as the other features of a client device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. An advertising method executed in a device, the method comprising:
obtaining and storing user identification information;
obtaining and storing user behavior information, wherein the user behavior information comprises operation information and viewing information;
updating an user preference information table according to the user identification information and the user behavior information, wherein the user preference information table comprises a plurality of indicator lists, and each of the indicator list comprises a plurality of indicators and corresponding indicator values;
generating an advertisement request according to the user preference information table and sending the advertisement request to an advertisement provider to receive at least one advertisement set, wherein the advertisement set comprises a plurality of advertisement data;
matching the received advertisement set with the stored user identification information and the stored user behavior information to select at least one advertisement data to be advertised; and
determining whether an advertisement display time is arrived according to operation behavior of a user of the device and the running state of the device, and advertising the advertisement data when the advertisement display time is arrived, wherein the step of determining whether an advertisement display time is arrived according to operation behavior of a user of the device and the running state of the device further comprises: if the operation behavior of the user is pausing the video playback, the advertisement display time is determined; and if the running state of the device is a sleep mode, the advertisement display time is determined;
evaluating the at least one advertisement data as one of an on-target advertisement and an off-target advertisement according to a browsing rate and a click rate; and
reporting to a provider when the at least one advertisement is evaluated as the off-target advertisement.

2. The advertising method of claim 1, wherein the step of generating an advertisement request according to the user preference information table further comprises: sorting the plurality of indicator values in the user preference information table; and selecting a predetermined number of indicators to be encapsulated into the advertisement request according to the plurality of indicator values after sorting.

3. The advertising method of claim 1, wherein the advertisement request further comprises area information of the device.

4. (canceled)

5. A client device for advertising, comprising:
a processor;
a storage medium for storing instructions, wherein the instructions are executed by the processor, and performs the following steps:
obtaining and storing user identification information;
obtaining and storing user behavior information, wherein the user behavior information comprises operation information and viewing information;
updating an user preference information table according to the user identification information and the user behavior information, wherein the user preference information table comprises a plurality of indicator lists, and each of the indicator list comprises a plurality of indicators and corresponding indicator values;
generating an advertisement request according to the user preference information table and sending the advertisement request to an advertisement provider to receive at least one advertisement set, wherein the advertisement set comprises a plurality of advertisement data;
matching the received advertisement set with the stored user identification information and the stored user behavior information to select at least one advertisement data to be advertised; and
determining whether an advertisement display time is arrived according to operation behavior of a user of the device and the running state of the client device, and advertising the advertisement data when the advertisement display time is arrived, wherein the step of determining whether an advertisement display time is arrived according to operation behavior of a user of the device and the running state of the device further comprises: if the operation behavior of the user is pausing the video playback, the advertisement display time is determined; and if the running state of the device is a sleep mode, the advertisement display time is determined;
evaluating the at least one advertisement data as one of an on-target advertisement and an off-target advertisement according to a browsing rate and a click rate; and
reporting to a provider when the at least one advertisement data is evaluated as the off-target advertisement.

6. The client device of claim 5, wherein the step of generating an advertisement request according to the user preference information table further comprises: sorting the plurality of indicator values in the user preference information table; and selecting a predetermined number of indicators to be encapsulated into the advertisement request according to the plurality of indicator values after sorting.

7. The client device of claim 5, wherein the advertisement request further comprises area information of the client device.

8. (canceled)

9. A system for advertising, comprising:
a client device is configured to obtain user identification information, user behavior information, and view information of at least one displayed advertisement data, and transmit to a server; and
the server is configured to update a user preference information table according to the user identification information and the user behavior information, the user preference information table comprises a plurality of indicator lists, and each of the indicator list comprises a plurality of indicators and corresponding indicator values; and the server is further configured to transmit an advertisement request to an advertisement provider according to the user preference information table, to receive at least one advertisement set, to differentiate the plurality of indicators in the user preference information table into a majority indicators and non-majority indicators according to properties of the indicators, and to perform data matching according to the viewing information of the at least one displayed advertisement data and the majority indicators to select a plurality of advertisement data form the advertisement set to be advertised through the client device.

10. (canceled)
